(19) United States
(12) Patent Application Publication
(10) Pub. No.: US 2008/0026095 A1
(43) Pub. Date: Jan. 31, 2008

(54) INJECTION MOLDING MACHINE

(75) Inventors: RALPH WESSELY, Burgthann (DE); Andreas Kubel, Lauf (DE); Hans-Jurgen Popp, Grafenburg (DE)

Correspondence Address: HENRY M FEIEREISEN, LLC, 350 FIFTH AVENUE, SUITE 4714, NEW YORK, NY, 10118, US

(73) Assignee: Demag Ergotech GmbH, Schwaig (DE)

(21) Appl. No.: 11/621,249

(22) Filed: Jan. 9, 2007

Related U.S. Application Data
(63) Continuation of application No. PCT/EP05/51801, filed on Apr. 22, 2005.

(30) Foreign Application Priority Data
Jul. 9, 2004 (DE) 10 2004 033 690.3

(51) Int. Cl. B29C 45/17

(52) U.S. Cl. 425/556; 425/590

(57) ABSTRACT

An injection molding machine includes an injection unit and a clamping unit. The injection unit includes a barrel and a plasticizing screw which is supported in the barrel for rotation and movement in axial direction. A first direct drive causes the plasticizing screw to rotate in order to plasticize thermoplastic material, and a hydraulic drive causes the plasticizing screw to move axially in order to effect an injection stroke. The hydraulic drive includes a hydraulic accumulator system which is comprised of a variable capacity pump in combination with a hydraulic accumulator. The clamping unit includes a toggle mechanism for moving a movable platen in relation to a stationary support platen, a spindle mechanism for operating the toggle mechanism, and a second direct drive for operating the spindle mechanism.

### CROSS-REFERENCES TO RELATED APPLICATIONS

This application is a continuation of prior filed copending PCT International application no. PCT/EP2005/051801, filed Apr. 22, 2005, which designated the United States and has been published but not in English as International Publication No. WO 2006/005638 and on which priority is claimed under 35 U.S.C. §120, and which claims the priority of German Patent Application, Serial No. 10 2004 033 690.3, filed Jul. 9, 2004, pursuant to 35 U.S.C. 119(a)-(d), the contents of which are incorporated herein by reference in its entirety as if fully set forth herein.

### BACKGROUND OF THE INVENTION

The present invention relates, in general, to an injection molding machine.

Nothing in the following discussion of the state of the art is to be construed as an admission of prior art.

A typical injection molding machine includes an injection unit having a plasticizing screw which is caused to rotate by an electric drive for plasticizing thermoplastic material, and which is caused to execute an injection stroke in axial direction by a hydraulic drive which is also used to apply back pressure and holding pressure. Examples of injection molding machines of this type are described in U.S. Pat. No. 5,935,494, issued on Aug. 10, 1999, or U.S. Pat. No. 6,120,277, issued on Sep. 19, 2000, or published U.S. Pat. Appl. No. 2003/0042640 A1, published Mar. 6, 2003.

It would be desirable and advantageous to provide an improved injection molding machine which obviates prior art shortcomings and which operates quietly, is low maintenance, compact and light and yet reliable in operation and especially suitable for high speed applications with high dynamics.

### SUMMARY OF THE INVENTION

According to one aspect of the present invention, an injection molding machine includes an injection unit and a clamping unit, with the injection unit having a barrel, a plasticizing screw supported in the barrel for rotation and movement in axial direction, a first direct drive for implementing the rotation of the plasticizing screw to plasticize thermoplastic material, and a hydraulic drive, implementing the axial movement of the plasticizing screw to effect an injection stroke, and including a hydraulic accumulator system comprised of a variable capacity pump in combination with a hydraulic accumulator, and with the clamping unit having a toggle mechanism for moving a movable platen in relation to a stationary support platen, a spindle mechanism for operating the toggle mechanism, and a second direct drive for operating the spindle mechanism.

The present invention resolves prior art problems by providing a direct drive as electrical drive for implementing the injection stroke of the plasticizing screw, and by providing a direct drive for activating the spindle mechanism. The use of such direct drives results in a very quiet operation in view of the reduced number of individual components compared to electric drives which include combinations of electric motors and transmissions. A direct drive is also lightweight and compact. The need for frequent maintenance works is eliminated because only the bearings of direct drives are subject to wear, however to a much less extent when compared to wear to which the numerous components of transmissions are exposed. As a result, downtimes of an injection molding machine according to the invention are less frequent. In addition, due to the absence of a transmission, the need for a separate cooling circuit is eliminated, and there is no need for a supply of transmission oil so that the injection molding machine according to the invention is not only compact but operates cleanly and at little noise level. Direct drives can also be precisely operated so that the metering function assumed by the plasticizing screw becomes very effective and accurate.

The presence of a hydraulic accumulator system in accordance with the present invention for supply of fluid to the hydraulic drive to effect the injection stroke of the plasticizing screw results in an injection molding machine that is also in compliance with all requirements demanded by a high-speed injection molding machine, such as demand for high dynamics. These requirements cannot be satisfied by hydraulic systems, using simply a pump for pressurizing the hydraulic circuit. The combination of a hydraulic accumulator system comprised of a variable-capacity pump and hydraulic accumulator ensures precise operation of the hydraulic drive. In other words, the hydraulic drive is under sufficient pressure at shot time so as to guarantee a precisely timed and rapid injection which is crucial for realizing fast cycling injection molding machines.

The combination of a small, light drive of low maintenance for the plasticizing screw with respective hydraulic accumulator system also realizes high injection cycles.

According to another feature of the present invention, the first direct drive for implementing the rotation of the plasticizing screw may be mounted to a carriage by which the attached injection unit can be moved in relation to a machine bed.

Electrically as well as hydraulically driven units can be rapidly activated and rapid opening and closing motions can also be realized through use of a clamping unit according to the invention. The clamping unit operates independently from other units and has the added benefit of being applicable for other types of injection units as well. The clamping unit may include a support platen, which is securely mounted onto the machine bed, and a moving platen which can be supported on the machine bed and travel in relation to the support platen through operation of a toggle mechanism.

According to another feature of the present invention, the second direct drive for operating the spindle mechanism may be articulated to the support platen or integrated in the support platen. In this way, the clamping unit becomes even more compact and space-saving. As an alternative, depending on the relative disposition of spindle and spindle nut of the spindle mechanism, it may also be conceivable to use a hollow-shaft motor having a rotor, with the spindle extending through the rotor.

According to another feature of the present invention, each of the first and second direct drives may be constructed in the form of a high-torque motor. In particular, the construction of the direct drive for the spindle mechanism in the form of a high-torque motor is beneficial because a high-torque drive has high moment compactness and can be precisely operated. This is important in connection for realizing a precise positioning of the movable platen. As a result, rapid startup and maximum speeds that are crucial for a rapid operation can be implemented.

According to another feature of the present invention, the first direct drive for implementing the rotation of the plasticizing screw may be configured in the form of a fairly slow operating high-torque motor by which the material to be plasticized can be subjected to a required torque so as to attain optimal plasticizing results. Such high-torque motors operate very efficiently and ensure high dynamics as a consequence of low energy consumption at same load in comparison to conventional drives, because of their short run-up time compared to conventional electric drives. In particular when applying synchronous technique, energy consumption can be further reduced because reduced stall current is drawn.

According to another feature of the present invention, the first direct drive for implementing the rotation of the plasticizing screw may have an output shaft and a spline shaft which is connected to the output shaft, wherein the spline shaft is connected in fixed rotative engagement with and axially displaceably connected to an injection plunger of the hydraulic drive. As a consequence, the injection unit becomes very compact and requires thus little space. A shaft of the plasticizing screw may be directly connected to the injection plunger so that the advance force transmitted by the hydraulic drive onto the injection plunger can be introduced along an axis of the plasticizing screw in the absence of any moments. Linkage through intervention of a spline shaft is easy to implement and easy to maintain.

According to another feature of the present invention, the first direct drive for implementing the rotation of the plasticizing screw may be constructed in the form of a hollow-shaft motor having a hollow shaft, with the spline shaft having a plunger-distal end which is received in and connected to the hollow shaft and thus to the rotor of the direct drive.

According to another feature of the present invention, the hydraulic drive has an injection cylinder in which the injection plunger may be supported for rotation and displacement in axial direction. Suitable seals are provided between the chambers of the hydraulic drive to provide good sealing action while still allowing full mobility.

According to another feature of the present invention, the injection unit may be movably supported on the machine bed via a carriage for approaching a stationary platen.

According to another feature of the present invention, the hydraulic accumulator system may be configured in such a way that various hydraulic actuators, constructed in particular as piston and cylinder units of different size and shape, can be supplied with fluid simultaneously and/or alternatingly. For example, the hydraulic accumulator system may feed all hydraulic drives to thereby ensure a compact structure and an efficient construction.

Especially useful is the application of the hydraulic accumulator system for high-speed operations as required in the field of fast cycling injection molding machines with high power consumption , stringent demands with respect to response times and cycling speed. This can be realized by suitably configuring the hydraulic accumulator system in coordination with a provided control unit, suitable drive for the hydraulic pump, and suitably sized hydraulic accumulator, feed lines and respectively controlled valves, such as proportional valves. Such a hydraulic accumulator system is able to attain injection speeds that are difficult to attain by electric drives such as a spindle drive for injection units.

In particular for high-speed applications with its demands on the dynamics of the entire injection molding machine and its various interacting components, the hydraulic accumulator system may be utilized for so-called ancillary axles, for example for rapid and precise operation of an ejector unit and/or core puller unit and/or nozzle advance unit. High-speed applications require all movements of an injection molding machine to be executed rapidly and precisely in synchronism with one another.

According to another feature of the present invention, the spindle of the spindle mechanism may be axially fixed to the clamping unit and articulated in particular to an output shaft of the second direct drive that operates the spindle mechanism. The spindle may be in engagement with a spindle nut which is connected to a crosshead of the toggle mechanism. In this way, the rotary acceleration of the spindle has only a small angular momentum so that high accelerations of the spindle mechanism can be attained.

According to another feature of the present invention, the spindle mechanism may be constructed in the form of a planetary spindle mechanism. This type of spindle mechanism exhibits good running properties. As a result of the roll-off movement between the spindle and the spindle nut by means of the two planets disposed between and engaging with the spindle and the spindle nut, such a spindle mechanism is exposed to little sliding friction and thus little wear and is able to operate quietly and at high efficiency while exhibiting high stress resistance.

According to another feature of the present invention, the spindle mechanism has a spindle constructed in the form of a high-speed spindle with a thread pitch in a range of greater than 40 mm. Currently preferred is a thread pitch of about 42 mm. The thread pitch of the spindle mechanism according to the present invention substantially exceeds thread pitches of conventional spindle mechanisms which typically range to 35 mm.

In order to obtain optimum results for high-speed applications, the second direct drive can be best suited to the requirements at hand. For example, according to another feature of the present invention, the second direct drive may be constructed to operate at increased rotation speed, e.g. in a range of above 750 revolutions per minute and above. Despite these high rotation speeds, the clamping unit of the injection molding machine according to the present invention can still run quietly and with low maintenance needs because of the use of a direct drive, and in addition, has a compact structure and slight dry cycle times as a result of the high accelerations and maximum speeds.

An injection molding machine according to the present invention is especially suited for high-speed applications with the required high dynamics and includes an injection unit which is also suited for high-speed applications with the required high dynamics. The provision of a hydraulic accumulator system for various axles of an injection molding machine with hydraulic actuators in combination with the provision of direct drives for electrically driven axles allows all axles of the injection molding machine to be activated independently from one another in a rapid and precise manner, wherein this activation can be best suited via a control mechanism of the hydraulic accumulator system to a control mechanism of the injection molding machine and together to the demands of high-speed applications.

### BRIEF DESCRIPTION OF THE DRAWING

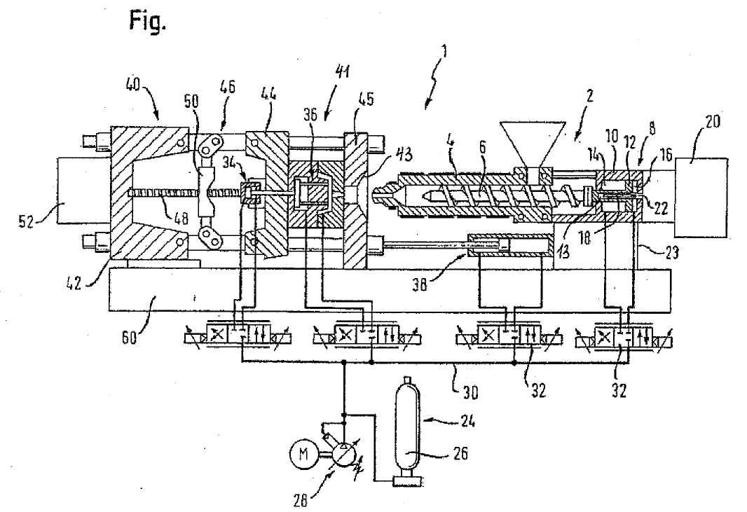

Other features and advantages of the present invention will be more readily apparent upon reading the following description of currently preferred exemplified embodiments of the invention with reference to the accompanying drawing, in which the sole FIG. 1 shows a schematic sectional view of an injection molding machine according to the present invention.

### DETAILED DESCRIPTION OF PREFERRED EMBODIMENTS

The depicted embodiment is to be understood as illustrative of the invention and not as limiting in any way. It should also be understood that the drawing is not necessarily to scale and that embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown a schematic sectional view of an injection molding machine according to the present invention, generally designated by reference numeral 1. The injection molding machine includes an injection unit which is generally designated by reference numeral 2, and a clamping unit, which is generally designated by reference numeral 40. The injection unit 2 has a plasticizing unit with a barrel 4 and a plasticizing screw 6, which is received in the barrel 4 for rotation and axial displacement. The injection unit 2 further includes a hydraulic drive in the form of a piston and cylinder unit 8 having an injection plunger 12 which is supported in an injection cylinder 10 for axial movement and rotation. The injection plunger 12 divides the interior space of the injection cylinder 10 in a first hydraulic chamber 14 and a second hydraulic chamber 16 and can be moved in axial direction by selectively admitting hydraulic fluid under pressure into the chambers 14, 16.

The plasticizing screw 6 is fixedly connected with the injection plunger 12 so as to conjointly move therewith in axial direction. The injection plunger 12 is formed with an axial pocket 13 in which a spline shaft 18 is able to plunge in. The spline shaft 18 is fixedly connected to an unillustrated output shaft of an electric direct drive 20. A rotation of the output shaft is transmitted by the spline shaft 18 onto the injection plunger 12 and ultimately onto the plasticizing screw 6.

Hydraulic fluid is admitted to the hydraulic chambers 14, 16 of the piston and cylinder unit 8 of the injection unit 2 by means of a hydraulic accumulator system 24 which includes a variable capacity pump 28, operated by a motor M, and a hydraulic accumulator 26 which stores a large amount of hydraulic fluid under pressure. For quick release of hydraulic fluid, the hydraulic accumulator 26 and the hydraulic pump 28 can hereby be connected with the hydraulic chambers 14, 16 of the piston and cylinder unit 8 by supply lines 30 and a switchable valve 32. Depending on the switching state of the valve 32, the plasticizing screw 6 can be moved towards or away from the direct drive 20, or acted upon by pressure, or decoupled from the hydraulic accumulator system 24 while maintaining the respective pressure.

The injection unit 2 is disposed upon a carriage 23 which is movably supported on a machine bed 60 of the injection molding machine 1. A hydraulically operated nozzle advance unit 38 is supplied with hydraulic fluid from the hydraulic accumulator system 24 and moves the injection unit 2 in a direction of the clamping unit 40. The clamping unit includes a support platen 42 which is fixedly mounted onto the machine bed 60, a moving platen 44 which is movable relative to the support platen 42, and a fixed platen 45. The injection unit 2 can hereby be pressed against a nozzle orifice 43 of the fixed platen 45 for injection of plasticized material into an injection mold 41.

The hydraulic accumulator system 24 is further operatively connected via supply lines 30 and valves 32 to a hydraulically operated ejector unit 34 and, optionally, to core puller units 36 in the event the type of product to be molded in the injection mold 41 requires their provision.

The clamping unit 40 of the injection molding machine 1 includes a toggle mechanism 46 which can be operated by a spindle mechanism comprised of a high-speed spindle 48 in mesh with an unillustrated spindle nut which is non-rotatably articulated to a crosshead 50 of the toggle mechanism. The high-speed spindle 48 is securely fixed to an output shaft of a direct motor 52. Rotation of the spindle 48 causes the crosshead 50 to move axially along the spindle 48 to thereby operate the toggle mechanism 46. As a consequence, depending on the rotation direction of the spindle 48, the moving platen 44 is caused to travel away from or towards the fixed platen 45 to open or close the injection mold 41.

At operation of the injection molding machine, all operating shafts or axles along which rotary or linear motions can be executed can be controlled independently from one another in a rapid and precise manner. Thus, all movements can be best suited to one another and carried out in shortest time periods. The hydraulic accumulator system 24 can be constructed in such a way that hydraulic fluid is filled into the accumulator 26 and pressurized during periods that do not require a supply of fluid to the hydraulic drives.

The provision of direct motors for the electric drives and the provision of a hydraulic accumulator system for operating the hydraulic components, a rapid acceleration can be realized along the individual shafts or axles so that such an injection molding machine is applicable as fast cycling machine in particular for high-speed applications.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. An injection molding machine, comprising:
an injection unit, including
a barrel,
a plasticizing screw supported in the barrel for rotation and movement in axial direction,
a first direct drive for implementing the rotation of the plasticizing screw to plasticize thermoplastic material, and
a hydraulic drive for implementing the axial movement of the plasticizing screw to effect an injection stroke, said hydraulic drive including a hydraulic accumulator system comprised of a variable capacity pump in combination with a hydraulic accumulator; and
a clamping unit, including
a toggle mechanism for moving a movable platen in relation to a stationary support platen,
a spindle mechanism for operating the toggle mechanism, and
a second direct drive for operating the spindle mechanism.

2. The injection molding machine of claim 1, wherein each of the first and second direct drives is a high-torque motor.

3. The injection molding machine of claim 1, wherein the hydraulic drive has an injection plunger, said first direct drive having an output shaft and a spline shaft which is connected to the output shaft, said spline shaft being connected in fixed rotative engagement with and axially displaceably connected to the injection plunger of the hydraulic drive.

4. The injection molding machine of claim 3, wherein the first direct drive is constructed in the form of a hollow-shaft motor having a hollow shaft, said spline shaft having a plunger-distal end which is received in and connected to the hollow shaft.

5. The injection molding machine of claim 3, wherein the hydraulic drive has an injection cylinder in which the injection plunger is supported for rotation and displacement in axial direction.

6. The injection molding machine of claim 1, further comprising a carriage for attachment of the injection unit, said carriage being movably supported on a machine bed.

7. The injection molding machine of claim 1, further comprising at least one member selected from the group consisting of ejector unit, core puller unit and nozzle advance unit, said hydraulic accumulator system being constructed to supply hydraulic fluid to the member.

8. The injection molding machine of claim 1, wherein the second direct drive is mounted on the support platen.

9. The injection molding machine of claim 1, wherein the second direct drive is integrated in the support platen.

10. The injection molding machine of claim 1, wherein the second direct drive has a rotor, said spindle mechanism having a spindle which is connected in fixed rotative engagement with the rotor.

11. The injection molding machine of claim 1, wherein the spindle mechanism is constructed in the form of a planetary spindle mechanism.

12. The injection molding machine of claim 1, wherein the spindle mechanism has a spindle constructed in the form of a high-speed spindle with a pitch in a range of greater than 40 mm.

13. The injection molding machine of claim 1, wherein the spindle mechanism has a spindle constructed in the form of a high-speed spindle with a pitch of about 42 mm.

14. The injection molding machine of claim 1, wherein the second direct drive is constructed to operate at increased rotation speed.

15. The injection molding machine of claim 1, wherein the second direct drive is constructed to operate at a rotation speed in a range of at least 750 revolutions per minute.
